(19) United States
(12) Patent Application Publication
(10) Pub. No.: US 2021/0126923 A1
(43) Pub. Date: Apr. 29, 2021

(54) Integrity verification chain for verifying integrity of devices and method for verifying integrity of devices using the same

(71) Applicant: GREEN ZONE SECURITY., LTD., Hyeonpung-myeon (KR)

(72) Inventor: Jin-Kyu Kim, Gaegun-myeon (KR)

(21) Appl. No.: 16/965,490

(22) PCT Filed: Nov. 25, 2019
(86) PCT No.: PCT/KR2019/016259

§ 371 Date: Jul. 28, 2020

(30) Foreign Application Priority Data
Jan. 31, 2019 (KR) 10-2019-0012543

(51) Int. Cl. H04L 29/06; H04L 9/32

(52) U.S. Cl. CPC H04L 63/126; H04L 9/3242; H04L 2209/38; H04L 9/3247; H04L 9/3263

(57) ABSTRACT

A device is disclosed. The device may comprise an integrity verification chain generating unit generating an integrity verification chain including at least one or more integrity verification blocks; and an integrity verification unit verifying integrity of the device by using the integrity verification chain,

### TECHNICAL FIELD

The present disclosure relates to an integrity verification chain for verifying integrity of devices and a method for verifying integrity of devices using the same.

### BACKGROUND ART

In general, integrity verification on a device uses a hash algorithm or digital signature technology. In the case of an application, a hash value of the corresponding application is usually distributed together when the application is distributed, and in the case of data, a hash value of important data is generated and compared with a stored hash value of the original data.

Also, in the case of digital signature, app signature technology that adds a signature to the application being distributed by using a certificate issued by a certificate authority and a private key or Digital Rights Management (DRM) technology that adds an digital signature to a document such as PDF/DOC is used.

These methods do not have countermeasures when both the application/file and hash data are forged/falsified and then installed on a device, nor do they have a means to periodically detect a security breach. Furthermore, it is difficult for a central server employing the methods to collect, detect, and react properly to integrity of various applications or various data included in a device.

Moreover, since no consistent means is available for a manager to duly perform a security test on a specific device, it is difficult to perform the integrity check simultaneously on various targets such as an application, a kernel, a bootloader, and an important datafile.

In addition, although a method that scans the whole file system, such as a vaccine program, may be utilized, this type of method may not be performed easily for a system with a limited amount of computing power such as an IoT device.

### DISCLOSURE

### Technical Problem

An object of the present disclosure is to provide a security method capable of solving the problems found in the conventional technology.

Also, an object of the present disclosure is to provide a security method capable of accurately detecting forgery and/or falsification of important assets such as key applications, data, and file system within a predetermined device.

### Technical Solution

A representative composition of the present disclosure for achieving the objects above is as follows.

A device according to an embodiment of the present disclosure may comprise an integrity verification chain generating unit generating an integrity verification chain including at least one or more integrity verification blocks; and an integrity verification unit verifying integrity of the device by using the integrity verification chain, wherein the integrity verification block may include current data including information on an integrity verification target and a message digest about a previous integrity verification block; and a message digest about the current data.

Also, an integrity verification system of a device according to an embodiment of the present disclosure may comprise a device generating an integrity verification chain including at least one or more integrity verification blocks; and a server obtaining the integrity verification chain from the device and verifying integrity of the device by using the integrity verification chain, wherein the integrity verification block may include current data including information on an integrity verification target and a message digest about a previous integrity verification block; and a message digest about the current data.

Also, a device integrity verification apparatus according to an embodiment of the present disclosure may comprise an integrity verification chain generating unit generating an integrity verification chain including at least one or more integrity verification blocks; and an integrity verification unit verifying integrity of the device by using the integrity verification chain, wherein current data and a message digest about the current data may be arranged together on the integrity verification block by the integrity verification chain generating unit. At this time, by the integrity verification chain generating unit, the current data may include information on an integrity verification target and a message digest about a previous integrity verification block. By the integrity verification chain generating unit, the current data may further include a message digest about a current block. When information on the integrity verification target is defined as first information, a message digest about the first information is defined as a first digest, a message digest about the previous integrity verification block is defined as a second digest, and a message digest about the current block is defined as a third digest, the third digest may include the first information, the first digest, and the second digest. When a message digest about the current data is defined as a fourth digest, the fourth digest may include a message digest about all of the current data including the first information, the first digest, the second digest, and the third digest by the integrity verification generating unit. A message digest about an integrity verification block in a configuration order including all of the first information, the first digest, the second digest, the third digest, and the fourth digest may become a message digest about a previous integrity verification block corresponding to a second digest in the next integrity verification block. The second digest included in the integrity verification block of the configuration order by the integrity verification chain generating unit may be used for generation of each of the third digest included in the integrity verification block of the configuration order, the fourth digest, and a message digest about the integrity verification block of the configuration order.

In addition to the above, further provided is a computer-readable recording medium recording a computer program for executing a different method and a different system implementing the present disclosure and the method above.

### Advantageous Effects

According to an embodiment of the present disclosure, a security method capable of accurately detecting forgery and/or falsification of important assets such as key applications, data, and a file system within a predetermined device may be provided.

Also, according to an embodiment of the present disclosure, security breach in important data installed in a device may be detected periodically by using integrity verification data connected in a blockchain.

Also, according to an embodiment of the present disclosure, integrity verification may be performed for various targets.

Also, according to an embodiment of the present disclosure, forgery and/or falsification of verification data itself may be prevented, and a security system resistant to man-in-the-middle attacks or replay attacks may be provided.

Also, according to an embodiment of the present disclosure, by adding a digital signature to a blockchain structure, data may be guaranteed to have been generated by a specific device.

Also, according to an embodiment of the present disclosure, by using a blockchain structure that may be generated efficiently and that does not allow the whole verification data to be forged and/or falsified easily, disadvantages in the conventional integrity verification systems may be compensated.

### DESCRIPTION OF DRAWINGS

FIG. 1 illustrates a device capable of verifying integrity of data according to one embodiment of the present disclosure.

FIG. 2 illustrates a structure of the device shown in FIG. 1.

FIG. 3 illustrates integrity verification blocks and a structure of an integrity verification chain according to one embodiment of the present disclosure.

FIG. 4 illustrates a structure of the whole system capable of verifying integrity of a device according to a request of a server.

FIG. 5 is a flow diagram illustrating an order according to which integrity of a device is verified according to one embodiment of the present disclosure.

FIG. 6 is a flow diagram illustrating an order according to which integrity of a device is verified according to another embodiment of the present disclosure.

FIG. 7 illustrates a computing device according to an embodiment of the present disclosure.

### MODE FOR DISCLOSURE

In what follows, embodiments of the present disclosure will be described in detail with reference to appended drawings so that those skilled in the art to which the present disclosure belongs may readily apply the present disclosure. However, the present disclosure may be implemented in various other forms and is not limited to a specific embodiment described in this document. Moreover, to describe the present disclosure without ambiguity, those elements not related to the description of the present disclosure have been omitted, and throughout the document, similar elements are given a similar reference symbol number.

In the present disclosure, repeated descriptions of the same elements will be omitted.

Also, in the present disclosure, if a constituting element is said to be ‘connected’ or ‘attached’ to other constituting element, it should be understood that the former may be connected or attached directly to the other constituting element, but there may be a case in which another constituting element is present between the two constituting elements. On the other hand, if a constituting element is said to be ‘directly connected’ or ‘directly attached’ to other constituting element, it should be understood that there is no other constituting element between the two constituting elements.

Also, terms used in the present disclosure are intended only for describing a specific embodiment and are not intended to limit the technical scope of the present disclosure.

Also, in the present disclosure, a singular expression should be understood to indicate a plural expression unless otherwise explicitly stated.

Also, in the present disclosure, the term ‘include’ or ‘have’ is used to indicate existence of an embodied feature, number, step, operation, element, component, or a combination thereof; and should not be understood to preclude the existence of or possibility of addition of one or more other features, numbers, steps, operations, elements, components, or a combination thereof.

Also, in the present disclosure, the term ‘and/or’ includes any one of a combination of a plurality of disclosed elements or a plurality of disclosed elements. In the present disclosure, the expression ‘A or B’ may mean ‘only A’, ‘only B’ or ‘both A and B’.

Also, in the present disclosure, if it is determined that a detailed description of known functions or configurations unnecessarily obscure the gist of the present disclosure, the detailed description thereof will be omitted.

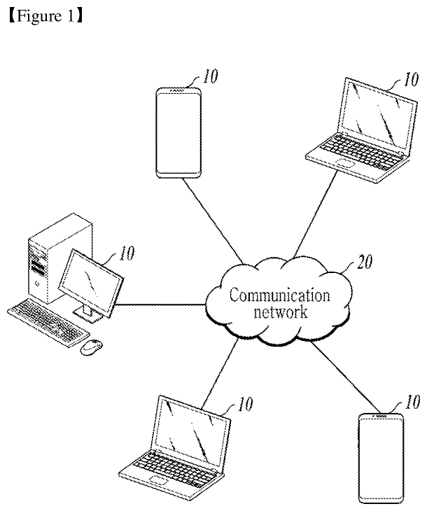

FIG. 1 illustrates a device capable of verifying integrity of data according to one embodiment of the present disclosure.

The device 10 according to an embodiment of the present disclosure is a digital device providing a function for communicating to and from the outside (for example, other device or server) through a communication network 20, which may correspond to at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device.

Or, the device 10 may be a home appliance such as a television, a digital video disk (DVD) player, an audio, a refrigerator, a cleaner, an oven, a microwave oven, a washing machine, an air cleaner, a set-top box, a home automation control panel, a security control panel, a TV box, game console, an electronic dictionary, an electronic key, and a camcorder.

Or, the device 10 may correspond to one of various types of medical devices (for example, various types of portable medical measurement devices (for example, a blood glucose monitoring device, a cardiotachometer, a blood pressure measuring device, or a body temperature measuring device), a magnetic resonance angiography (MRA) device, a magnetic resonance imaging (MRI) device, a computed tomography (CT) device, an imaging device, or an ultrasonic equipment), a navigation device, a global navigation satellite system (GNSS) device, an event data recorder (EDR), a flight data recorder (FDR), a car infotainment device, a ship electronic equipment (for example, a ship navigation device and a gyrocompass), an avionics device, a security device, a vehicle head unit, an industrial or home robot, an automatic teller's machine (ATM) in a financial institution, a point of sales (POS) device in a store, or an Internet of things (IoT) device (for example, a lightbulb, various kinds of sensors, an electricity or gas meter, a sprinkler device, a fire alarm device, a thermostat, a street light, a toaster, physical exercise equipment, a hot water tank, a heater, and a boiler).

Also, whichever digital device may be adopted as a device 10 according to the present disclosure as long as the digital device is equipped with a memory means and has computing capability from an installed microprocessor; moreover, the present disclosure is not limited to the devices described above but may include new electronic devices due to technological advances.

The device 10 according to an embodiment of the present disclosure may generate an integrity verification chain by which device integrity may be verified, and functions and a structure of the device 10 will be described in more detail below.

Next, the communication network 20 according to one embodiment of the present disclosure may be a high-speed backbone network of a large-scale communication network capable of providing data transmission and reception services or the next-generation wireless network including Wi-Fi, WiGig, Wireless Broadband Internet (Wibro), and World Interoperability for Microwave Access (Wimax) for providing Internet services or high-speed multimedia services.

The Internet may mean a world-wide open computer network structure that supports the TCP/IP protocol and various services defined on the upper layer of the protocol, the services including Hyper Text Transfer Protocol (HTTP), Telnet, Filter Transfer Protocol (FTP), Domain Name System (DNS), Simple Mail Transfer Protocol (SMTP), Simple Network Management Protocol (SNMP), Network File Service (NFS), and Network Information Service (NIS); and may provide an environment in which different kinds of devices 10 may communicate with each other.

Meanwhile, the Internet may be a wired or wireless Internet or may be a core network integrated with a wired public network, a wireless mobile communication network, or the portable Internet.

If the communication network 20 is a mobile communication network, the communication network 20 may be a synchronous mobile communication network or an asynchronous mobile communication network. An example of the asynchronous mobile communication network may be a communication network based on the Wideband Code Division Multiple Access (WCDMA) scheme. In this case, although not shown in the figure, the mobile communication network may include, for example, an Radio Network Controller (RNC). Meanwhile, although the WCDMA network has been chosen as an example, the mobile communication network may further include the 3G LTE network, 4G network, the next-generation communication network such as the 5G network, and any IP network based on the IP.

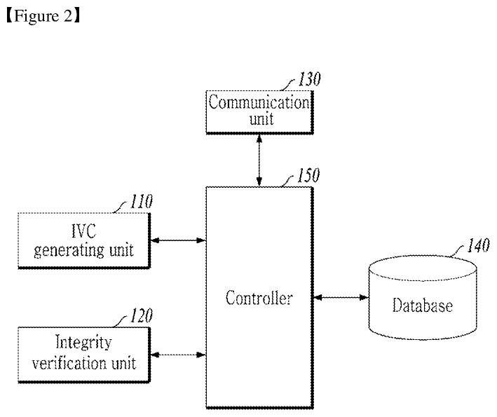

FIG. 2 illustrates a structure of the device shown in FIG. 1.

Referring to FIG. 2, the device 10 according to an embodiment of the present disclosure may comprise an integrity verification chain (hereinafter, IVC) generating unit 110, an integrity verification unit 120, a communication unit 130, a database 140, and a controller 150. According to one embodiment of the present disclosure, at least part of the IVC generating unit 110, the integrity verification unit 120, the communication unit 130, the database 140, and the controller 150 may be a program module communicating with the outside (for example, another device or a server). The program module may be included in the device 10 in the form of an operating system, an application program module, or other type of program module; and may be stored physically in various types of well-known storage devices. Also, the program module may be stored in a remote storage device capable of communicating with the device 10. Meanwhile, although the program module may perform a specific task to be described later according to the present disclosure or may include a routine, a subroutine, a program, an object, a component, or a data structure that executes a specific abstract data type, the present disclosure is not limited to the example above.

The IVC generating unit 110 may perform the function of generating an IVC.

The IVC may include at least one or more integrity verification blocks, wherein an integrity verification block may indicate verification data by which integrity of the device 10 may be verified, and forgery and/or falsification of data may be detected.

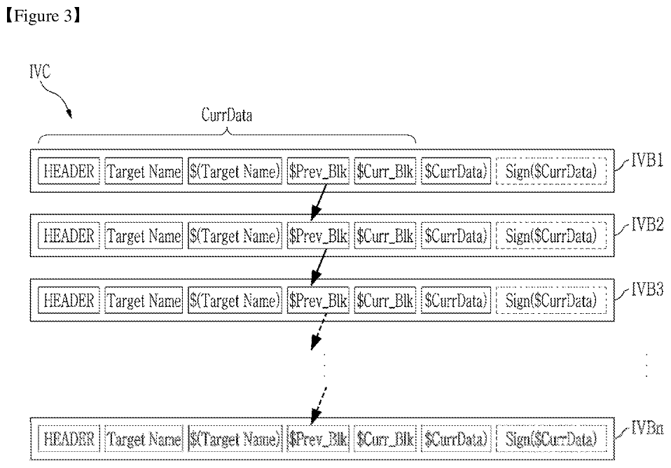

The integrity verification blocks generated by the IVC generating unit 110 and a structure of the IVC according to one embodiment of the present disclosure will be described in detail below with reference to FIG. 3.

FIG. 3 illustrates integrity verification blocks and a structure of an integrity verification chain according to one embodiment of the present disclosure.

Referring to FIG. 3, an IVC may include at least one or more integrity verification blocks (IVB1 to IVBn), and the integrity verification blocks (IVB1 to IVBn) may be connected to each other in the form of a chain (where n is a natural number equal to or larger than 1).

Each of the integrity verification blocks (IVB1 to IVBn) may include current data (CurrData), a message digest ($(CurrData)) about the current data (CurrData), and certificate data (Sign($CurrData)) about the current data (CurrData).

The current data (CurrData) may include a header structure (HEADER), an integrity verification target structure (TargetName), a message digest ($(TargetName)) about the integrity verification target structure (TargetName), a message digest ($Prev_Blk) about the entire previous blocks, and a message digest ($Curr_Blk) about a current block.

The header structure (HEADER) may include information indicating that the current block is an integrity verification block and information on the time when the corresponding block has been generated and the order in which the corresponding block has been generated. Also, the header structure (HEADER) may include additional information such as the information of a system that has generated the corresponding block (for example, identification (ID) information of the device 10). For example, the header structure (HEADER) of the n-th integrity verification block (IVBn) may include information indicating that the n-th integrity verification block (IVBn) is an integrity verification block (IVBn), information on the time when the n-th integrity verification block (IVBn) has been generated, and information indicating that the n-th integrity verification block (IVBn) corresponds to the n-th block among the integrity verification blocks. Here, the order of integrity verification blocks may be determined according to the time each integrity verification block is generated. In other words, an integrity verification block generated after the first integrity verification block (IVB1) is generated may become the second integrity verification block (IVB2).

The integrity verification target structure (TargetName) may include information on a target of which the integrity is to be verified and more specifically, may include information on the identifier and the name of a target of which the integrity is to be verified. For example, if the n-th integrity verification block (IVBn) is intended for integrity verification of a file including personal information of a user of the device 10, the integrity verification target structure (TargetName) may include a filename of the file.

The message digest ($(TargetName)) about the integrity verification target structure (TargetName) may indicate a message digest that abbreviates the integrity verification target structure (TargetName), wherein a message digest, which is a character string defined uniquely for each message, may indicate a checksum for checking forgery and/or falsification of the original data or for detecting an data error.

The message digest about the entire previous blocks ($Prev_Blk) may indicate a message digest that abbreviates the entire previous blocks. For example, the message digest about the entire previous blocks ($Prev_Blk) belonging to the n-th integrity verification block (IVBn) may be a message digest about the (n−1)-th integrity verification block. In other words, as a current integrity verification block includes a message digest about the entire previous blocks, integrity verification blocks (IVB1 to IVBn) may be connected to each other in a chained form.

The message digest about a current block ($Curr_Blk) may be a message digest about a currently generated block and more specifically, may be a message digest about the header structure (HEADER), the integrity verification target structure (TargetName), the message digest about the integrity verification target structure (TargetName), and the message digest about the entire previous blocks ($Prev_Blk).

The message digest ($(CurrData)) about the current data (CurrData), including the header structure (HEADER), the integrity verification target structure (TargetName), the message digest ($(TargetName)) about the integrity verification target structure (TargetName), the message digest ($Prev_Blk) about the entire previous blocks, and the message digest ($Curr_Blk) about the current block, may be a message digest that abbreviates the current data (CurrData).

The certificate data (Sign($CurrData)) may indicate the information certifying that a specific device has generated the corresponding block, in particular, the current data (CurrData).

More specifically, the verification data (Sign($CurrData)) may be the data generated by the device 10 or a digital signature technique using a private key of the owner of the device 10 or the data generated by a technique such as message authentication code (MAC) using a secret key or secret key encryption.

For example, the verification data (Sign($CurrData)) may have been digitally signed by a private key of the device 10, and an input value used for the digital sign may be the message digest ($(CurrData)) about the current data (CurrData). In this case, through the generated digital sign, it may be certified that the corresponding integrity verification block has been generated from a specific device, and a public key corresponding to the personal key may be needed for verification of the generated digital sign.

Or, the certificate data (Sign($CurrData)) may be a message authentication code, and by using a key used for generation of a message authentication mode, it may be verified that the message authentication code has been generated by a specific device.

Or, the certificate data (Sign($CurrData)) may be an encryption value generated through a predetermined encryption algorithm, and by using the key used for generation of the encryption value, it may be verified that the encryption value has been generated by a specific device.

Meanwhile, although FIG. 3 illustrates the case where certificate data (Sign($CurrData)) is included in each of the integrity verification blocks (IVB1 to IVBn), the present disclosure is not limited to the specific case, and depending on the situations, the certificate data (Sign($CurrData)) may be omitted.

For example, when the verification data (Sign($CurrData)) is a digital sign, a message authentication code, or an encryption value, information on a public key and a secret key needs to be shared between the device 10 and a server to be described later; when it is difficult to securely manage the public key and the secret key or a security level required by the user is low, the certificate data (Sign($CurrData)) may be omitted. In this case, the message digest ($Curr_Blk) about the current block included in the current data (CurrData) may perform the function of the certificate data (Sign($CurrData)).

The IVC generating unit 110 may generate an integrity verification block every predetermined period of time (for example, 24 hours) and generate an IVC including the newly generated integrity verification block.

The integrity verification unit 120 may perform the function of verifying integrity of the device 10 by using the IVC generated by the IVC generating unit 110 and may include a predetermined program by which integrity may be verified. For example, the integrity verification unit 120 may verify integrity of the device 10 by using a previous IVC and a current IVC.

The integrity verification unit 120 may check the time when an integrity verification block to be verified in the IVC has been generated, the order according to which the integrity verification block has been generated, and whether a filename thereof has been changed. Through the checking, it may be confirmed whether the corresponding integrity verification block itself has been forged and/or modified.

Or, the program may have been designed to cause an error when the contents of a target file have been changed, when a hash value of the target file has been changed, when a hash value of a previous block has been changed, or when certificate data (Sign($CurrData)) included in an integrity verification block is not correct; and the integrity verification unit 120 may verify integrity of the device 10 by referring to the error.

In other words, according to one embodiment of the present disclosure, integrity verification of the device 10 may be performed within the device 10 itself.

Next, the communication unit 130 according to one embodiment of the present disclosure may perform the function of transmitting and receiving data to or from the IVC generating unit 110, the integrity verification unit 120, and the database 140.

Next, the database 140 according to one embodiment of the present disclosure may store an IVC. Although FIG. 2 assumes that the database 140 is arranged to be included in the device 10, the database 140 may be arranged separately from the device 10 depending on the needs of those skilled in the art who implement the present disclosure. Meanwhile, the database 140 of the present disclosure should be regarded as a concept including a computer-readable recording medium, which may indicate not only a database in a narrow sense but also a database in a broad sense including data recording based on a file system; therefore, a set of simple logs may become the database 140 according to the present disclosure once the set of simple logs may be searched and data may be extracted therefrom.

Lastly, the controller 150 according to one embodiment of the present disclosure may perform the function of controlling a data flow among the IVC generating unit 110, the integrity verification unit 120, the communication unit 130, and the database 140. In other words, the controller 150 according to the present disclosure may control the IVC generating unit 110, the integrity verification unit 120, the communication unit 130, and the database 140 to perform their own functions by controlling a data flow to or from the outside of the device 10 or a data flow among individual constituting elements of a server.

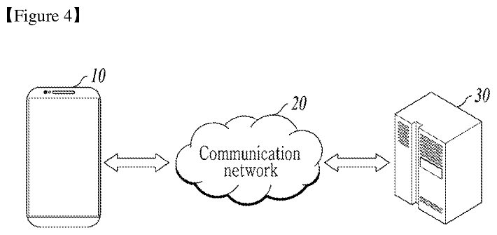

FIG. 4 illustrates a structure of the whole system capable of verifying integrity of a device according to a request of a server.

Referring to FIG. 4, the device 10 and the server 30 may communicate with each other through the communication network 20; for example, the server 30 may request the device 10 to transmit an IVC through the communication network 20 and obtain the IVC from the device 10.

The server 30 may verify integrity of the device 10 by using the IVC obtained from the device 10, for which a program included in the integrity verification unit 120 described above may also be included in the server 30.

Meanwhile, although FIG. 4 illustrates only one device 10, the present disclosure is not limited to the specific illustration, and the server 30 may perform the function of monitoring at least one or more devices 10.

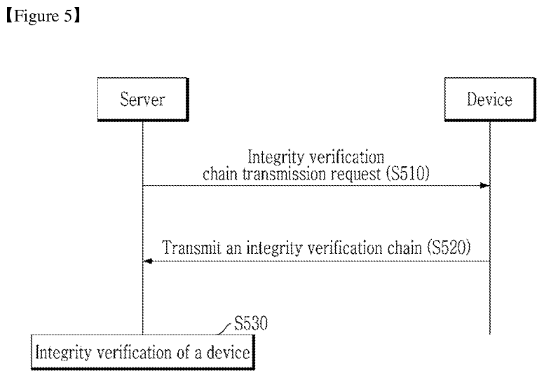

FIG. 5 is a flow diagram illustrating an order according to which integrity of a device is verified according to one embodiment of the present disclosure.

Referring to FIG. 5, the server 30 may transmit a request message requesting the device 10 to transmit an IVC to the device 10 S510.

Receiving the request message from the server 30, the device 10 may transmit an IVC to the server 30 S520.

By using the IVC obtained from the device 10, the server 30 may verify integrity of the device 10, and the integrity verification step of the device 10 may be performed by using the same method as performed in the integrity verification unit 120 of the device 10.

As a result of integrity verification, if forgery and/or falsification of the device 10 or data generated in the device 10 is detected, the server 30 may notify a predetermined manager of the detection and take an action such as preventing the device 10 from accessing the server 30 or other system.

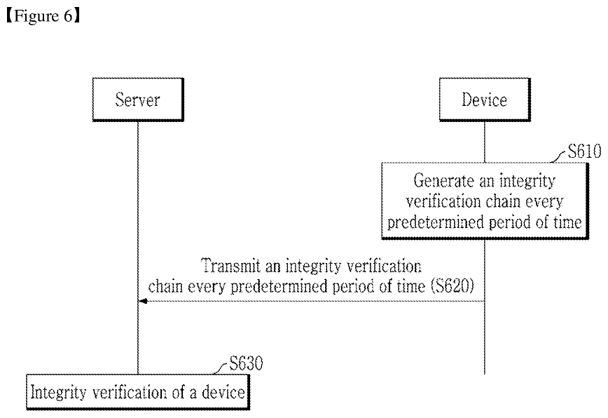

FIG. 6 is a flow diagram illustrating an order according to which integrity of a device is verified according to another embodiment of the present disclosure.

Referring to FIG. 6, the device 10 may generate an IVC every predetermined period of time S610. Even if no particular request message is received from the server 30, the device 10 may transmit a generated IVC to the server 30 S620.

The server 30 may verify integrity of the device 10 by using the IVC obtained from the device 10 (for example, by comparing a previously received IVC with a currently received IVC), and the integrity verification step of the device 10 may be performed by using the same method as performed by the integrity verification unit 120 of the device 10.

If an integrity breach is detected in the device 10 from the integrity verification result, the server 30 may notify a predetermined manager of the detection and take an action such as preventing the device 10 from accessing the server 30 or other system.

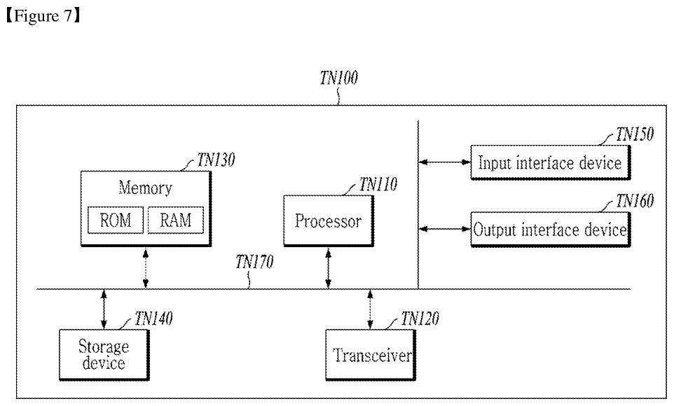

FIG. 7 illustrates a computing device according to an embodiment of the present disclosure. The computing device TN100 of FIG. 7 may be a device described in the present disclosure (for example, the device 10 or the server 30).

In the embodiment of FIG. 7, the computing device TN100 may include at least one processor TN110, a transceiver TN120, and a memory TN130. Also, the computing device TN100 may further include a storage device TN140, an input interface device TN150, and an output interface device TN160. The constituting elements included in the computing device TN100 are connected to each other via the bus TN170 to perform communication with each other.

The processor TN110 may execute program commands stored in at least one of the memory TN130 and the storage device TN140. The processor TN110 may mean a central processing unit (CPU), a graphics processing unit (GPU), or a dedicated processor in which methods according to an embodiment of the present disclosure are performed. The processor TN110 may be configured to implement procedures, functions, and methods described with respect to the embodiments of the present disclosure. The processor TN110 may control each individual constituting element of the computing device TN100.

Each of the memory TN130 and the storage device TN140 may store various pieces of information related to the operation of the processor TN110. Each of the memory TN130 and the storage device TN140 may be constructed by using at least one of a volatile storage medium and a non-volatile storage medium. For example, the memory TN130 may be configured by using at least one of read only memory (ROM) and random access memory (RAM).

The transceiver TN120 may transmit or receive a wired signal or a wireless signal. The transceiver TN120 may be connected to a network to perform communication.

The embodiments of the present disclosure described above may be implemented in the form of program commands which may be executed through various types of computer means and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be configured to be operated by one or more software modules to perform the operations of the present disclosure, and vice versa.

Meanwhile, it does not necessarily imply that the embodiments of the present disclosure may be implemented only through the device and/or the method described so far. The embodiments may also be implemented by a program that embodies the functions corresponding to the configurations of the embodiments of the present disclosure or by a recording medium recording the program, wherein the implementation may be easily done by those skilled in the art to which the present disclosure belongs from the description of the embodiments above.

In the above, embodiments of the present disclosure have been described in detail; however, the technical scope of the present disclosure is not limited to the embodiments, and various modifications and upgrades performed by those skilled in the art by using the basic principles of the present disclosure defined by the appended claims should also be considered to belong to the technical scope of the present disclosure.

1. A device, comprising:
an integrity verification chain generating unit generating an integrity verification chain including at least one or more integrity verification blocks; and
an integrity verification unit verifying integrity of the device by using the integrity verification chain,
wherein the integrity verification block includes current data including information on an integrity verification target and a message digest about a previous integrity verification block;
and a message digest about the current data.

2. The device of claim 1, wherein the current data further comprises:
a header structure including information on the time when the integrity verification block has been generated, an order of the integrity verification block, and ID of the device;
an integrity verification target structure including a filename of the integrity verification target;
a message digest about the integrity verification target structure; and
a message digest about the previous integrity verification block in addition to the header structure, the integrity verification target structure, and the message digest about the integrity verification target structure.

3. The device of claim 2, wherein the integrity verification block further includes certificate data,
wherein the certificate data is digitally signed by using a private key of the device, and
a message digest about the current data is used as an input value at the time of digital signing.

4. The device of claim 2, wherein the integrity verification block further comprises certificate data,
wherein the certificate data is one of a message authentication code or an encryption value generated through a predetermined encryption algorithm.

5. The device of claim 1, wherein the integrity verification chain generating unit updates the integrity verification chain by generating the integrity verification block every predetermined period of time.

6. A system for verifying integrity of a device, the system comprising:
a device generating an integrity verification chain including at least one or more integrity verification blocks; and
a server obtaining the integrity verification chain from the device and verifying integrity of the device by using the integrity verification chain,
wherein the integrity verification block includes current data including information on an integrity verification target and a message digest about a previous integrity verification block;
and a message digest about the current data.

7. The system of claim 6, wherein the server transmits the integrity verification chain transmission request message to the device, and
the device transmits the integrity verification chain to the server in response to the request message.

8. The system of claim 6, wherein the device updates the integrity verification chain by generating the integrity verification block every predetermined period of time and transmits the integrity verification chain updated every predetermined period of time to the server.

9. The system of claim 6, wherein the server verifies integrity of the device by comparing a currently obtained integrity verification chain with a previously obtained integrity verification chain.

10. The system of claim 9, wherein the current data further comprises:
a header structure including information on the time when the integrity verification block has been generated, an order of the integrity verification block, and ID of the device;
an integrity verification target structure including a filename of the integrity verification target;
a message digest about the integrity verification target structure; and
a message digest about the previous integrity verification block in addition to the header structure, the integrity verification target structure, and the message digest about the integrity verification target structure.

11. The system of claim 10, wherein, when it is found from integrity verification of the device that information on at least one of the time when the integrity verification block has been generated, an order of the integrity verification block, and the filename has been changed, the server determines that integrity of the device has been breached.

12. The system of claim 6, wherein the device includes an integrity verification unit verifying integrity of the device by using the integrity verification chain.

13. The system of claim 6, wherein the integrity verification block further includes certificate data,
wherein the certificate data is digitally signed by using a private key of the device, and
a message digest about the current data is used as an input value at the time of digital signing.

14. The system of claim 6, wherein the integrity verification block further comprises certificate data,
wherein the certificate data is one of a message authentication code or an encryption value generated through a predetermined encryption algorithm.

15. A device, comprising:
an integrity verification chain generating unit generating an integrity verification chain including at least one or more integrity verification blocks; and
an integrity verification unit verifying integrity of the device by using the integrity verification chain,
wherein current data and a message digest about the current data are arranged together on the integrity verification block by the integrity verification chain generating unit;
by the integrity verification chain generating unit, the current data includes information on an integrity verification target and a message digest about a previous integrity verification block;
by the integrity verification chain generating unit, the current data further includes a message digest about a current block;
information on the integrity verification target is defined as first information, a message digest about the first information is defined as a first digest, and a message digest about the previous integrity verification block is defined as a second digest;
when a message digest about the current block is defined as a third digest, the third digest includes the first information, the first digest, and the second digest;
when a message digest about the current data is defined as a fourth digest, the fourth digest includes a message digest about all of the current data including the first information, the first digest, the second digest, and the third digest by the integrity verification generating unit;
a message digest about an integrity verification block in a configuration order including all of the first information, the first digest, the second digest, the third digest, and the fourth digest becomes a message digest about a previous integrity verification block corresponding to a second digest in the next integrity verification block; and
the second digest included in the integrity verification block of the configuration order by the integrity verification chain generating unit is used for generation of each of the third digest included in the integrity verification block of the configuration order, the fourth digest, and a message digest about the integrity verification block of the configuration order.
